(19) United States
(12) Patent Application Publication
(10) Pub. No.: US 2003/0093288 A1
(43) Pub. Date: May 15, 2003

(54) Method and system for factory inspection

(75) Inventors: Yoshinobu Imabeppu, Kawasaki (JP); Hiroko Yada, Kawasaki (JP); Takanori Hashimoto, Kawasaki (JP); Hiroshi Sano, Kawasaki (JP); Daisuke Hashimoto, Kawasaki (JP); Minoru Fujita, Kawasaki (JP); Seigo Takahashi, Kawasaki (JP); Naoto Kudo, Hirosaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/091,146

(22) Filed: Mar. 6, 2002

(30) Foreign Application Priority Data
Nov. 9, 2001 (JP) 2001-344351

(51) Int. Cl. G06F 17/60

(52) U.S. Cl. 705/1

(57) ABSTRACT

The present invention relates to a method and system for factory inspection to be carried out by a client, having an object to provide a method and system for factory inspection capable of carrying out an proper factory inspection easily and rapidly. When carrying out a factory inspection, a client section transmits a desired inspection item to a server section through a communication network to receive the subject-of-inspection data selected on the basis of the inspection item through the communication network.

### BACKGROUND OF THE INVENTION

1. Field of the Invention

The present invention relates to a method and system for factory inspection to be carried out by the client.

2. Description of the Related Art

Conventionally, the inspection of a factory or the like has been carried out by a supplier who received the inspection items the client has previously presented. Meanwhile, in the conventional factory inspection, the client is required to actually observe a subject of inspection. Thus, there is a need for a client to actually visit a factory even though the factory is located far in address from the client.

In the conventional factory inspection as above, both the client and the supplier are required to take a complicated proceeding after the client has offered a desire for inspection to the supplier. Thus, there is a problem of requiring a long time before conducting an actual inspection. Accordingly, a problem arises that the client be dissatisfied with the slow response of the supplier.

Meanwhile, conventionally, there is a problem with passive response that a factory inspection is first conducted after the supplier has received a request for factory inspection from a client. Consequently,a problem arises that there is difficulty in obtaining, in early stage, the inspection data required by the client.

### SUMMARY OF THE INVENTION

It is an object of the present invention to provide a method and system for factory inspection capable of properly conducting an inspection easily and rapidly.

The foregoing object is to be achieved by a method for factory inspection comprising the steps of transmitting a desired inspection item through a communication network when conducting a factory inspection, and receiving subject-of-inspection data selected on the basis of the inspection item through the communication network.

### BRIEF DESCRIPTION OF THE DRAWINGS

FIG. 1 is a diagram showing a schematic configuration of a factory inspecting system according to an embodiment of the present invention;

FIG. 2 is a diagram typically showing a flow of data when a stamp of a date/hour and position is inserted to image data by the factory inspecting system according to the embodiment of the invention;

FIG. 3 is a diagram showing a flow of data in the factory inspecting method according to the embodiment of the invention;

FIG. 4 is a diagram showing a flow of data in the factory inspecting method according to the embodiment of the invention; and

FIGS. 5A-5E are figures showing examples of display screens to be displayed on a PC browser screen in the factory inspecting method according to the embodiment of the invention.

### DETAILED DESCRIPTION OF THE PREFERRED EMBODIMENT

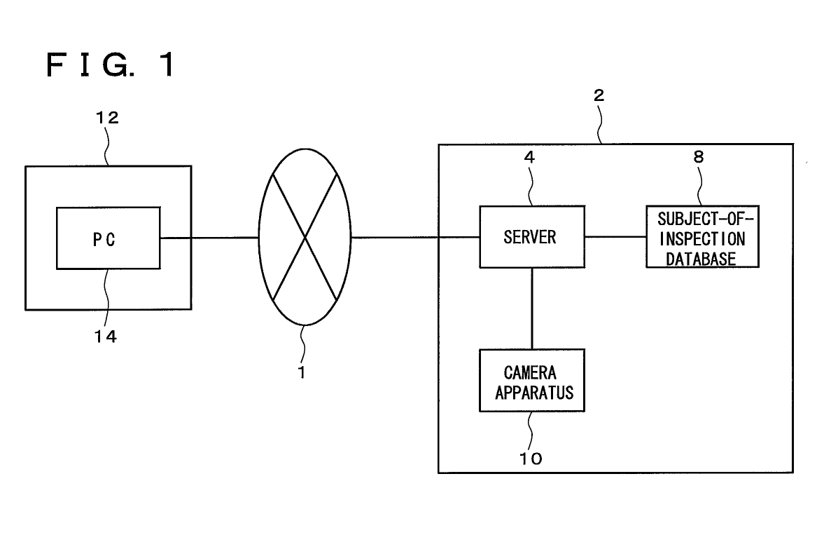

Explanation is made on a method and system for factory inspection according to one embodiment of the present invention, using FIG. 1 to FIG. 5E. FIG. 1 shows a schematic configuration of a factory inspection system according to the present embodiment. As shown in FIG. 1, the factory inspection system of the embodiment is configured with a supplier (server section) 2 and a plurality of client sections (one only is shown in FIG. 1) 12 connected to the server section 2 through a communication network 1.

The communication network 1 is a network of either a domestic or international value added network (VAN), or a combination thereof. A combination example of domestic and international value added networks includes so-called the Internet. This also includes a communication network including, as a network constituent element, a digital public telephone line, such as a packet communication network and an ISDN (Integrated Services Digital Network), to be utilized in data transfer with cellular phones or the like. Meanwhile, the communication network linking a digital television broadcast network (including both the wireless and the wired such as cable televisions) with a public telephone line is also included in the communication network 1 of the embodiment. Thus, the communication network 1 of the embodiment refers to a broad concept including any of these various forms of communication networks and combinations thereof.

The client section 12 is configured with a terminal having communication and browser functions, such as a PC (Personal Computer) 14.

The server section 2 has a server 4 and a subject-of-inspection database 8 storing the data concerning a subject of inspection, etc. The subject-of-inspection database 8 stores, as subject-of-inspection data, the image data of a subject of inspection and so on.

Meanwhile, the server section 2 has a camera apparatus 10, such as a digital video camera, as one of inspecting apparatus. The camera apparatus 10 is arranged to take a picture of a subject of inspection in a factory, to generate image data (e.g. animation) as subject-of-inspection data. Although not shown, the other inspecting devices include a monitor apparatus to acquire, as subject-of-inspection data, an operating state of a manufacturing equipment within the factory. By employing as a camera apparatus 10 a monitor camera conventionally installed for monitoring, the initial cost can be reduced as compared to newly setting up a camera apparatus 10 for monitoring. Note that, differently from the monitoring image data satisfactorily storing image data for a predetermined period in order for utilization upon an occurrence of accident or the like, it is required to download the image data which is at an arbitrary date/hour and location requested by a client. For this reason, there is a need for desired image data to be retrieved by the use of a date/hour or position as a keyword instead of merely storing past image data.

Meanwhile, the client, in many cases, requests subject-of-inspection data by designating a generation date/hour of subject-of-inspection data or a position of inspecting apparatus for generation of subject-of-inspection data. For this reason, it must be certified that the relevant subject-of-inspection data be of the generation date/hour or position of an inspecting apparatus desired by the client. Similarly, where real-time subject-of-inspection data is requested by the client, certification must be made that it is actually real-time subject-of-inspection data. Accordingly, the subject-of-inspection data such as image data, after added with stamping of a data generation date/hour and position of an inspecting apparatus generated the data, is saved to the subject-of-inspection database 8. The subject-of-inspection data is added by the data of a client, product kind, lot, process and so on.

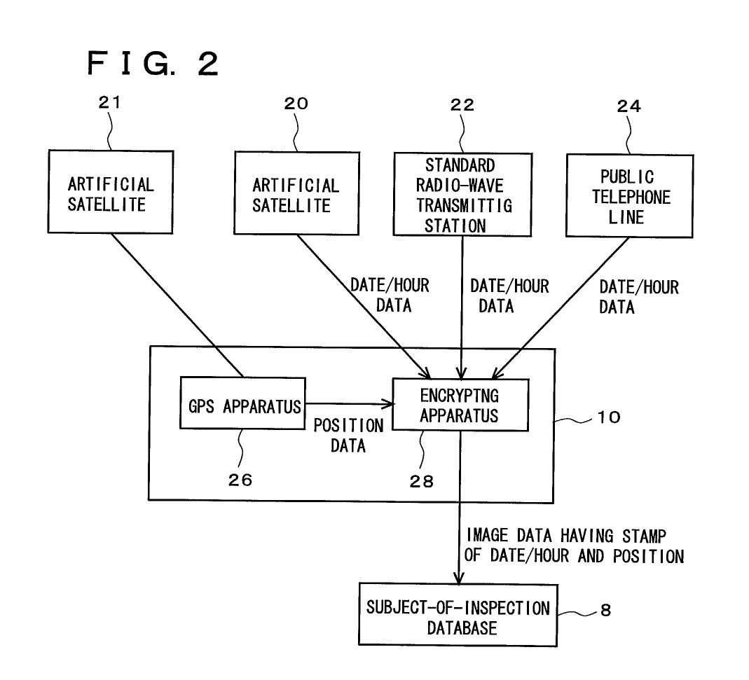

FIG. 2 typically shows one example of data flow upon inserting a stamp of a date/hour and position into image data. As shown in FIG. 2, the camera apparatus 10 has a GPS (Global Positioning System) apparatus 26 and an encrypting apparatus 28. The GPS apparatus 26 receives radio waves transmitted from a plurality of artificial satellites 21 to acquire position data, and transmits the position data of the camera apparatus 10. The encrypting apparatus 28 receives date/hour data of any of a public standard time signal transmitted from the satellite 20 or standard radio-wave transmitting station 22 and a time signal transmitted through a public telephone line 24, and the position data transmitted from the GPS apparatus 26. In the case that the camera apparatus 10 does not have a GPS apparatus 26, it is possible to use a serial number or the like of the camera apparatus 10 in place of position data.

The encrypting apparatus 28 is arranged to add a stamp of an encrypted date/hour and position to the image data generated in the camera apparatus 10, on the basis of the above date/hour data and position data. At this time, by storing such a program that a stamp is prohibited from being combined by editing the image data within a storage device of the server 4, it is possible to previously prevent the information of date/hour and position from being changed by the server 4. The image data added with a stamp of date/hour and position is written to the subject-of-inspection database 8.

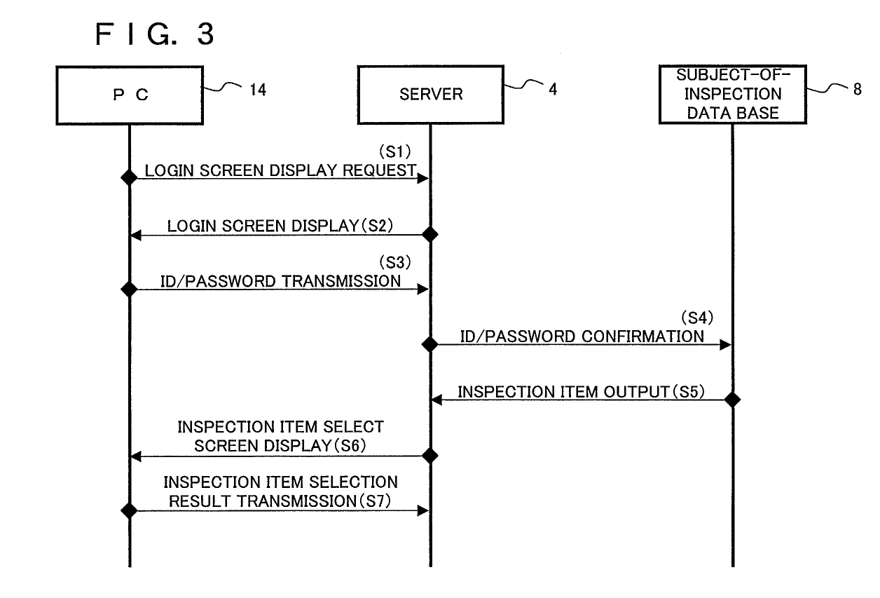

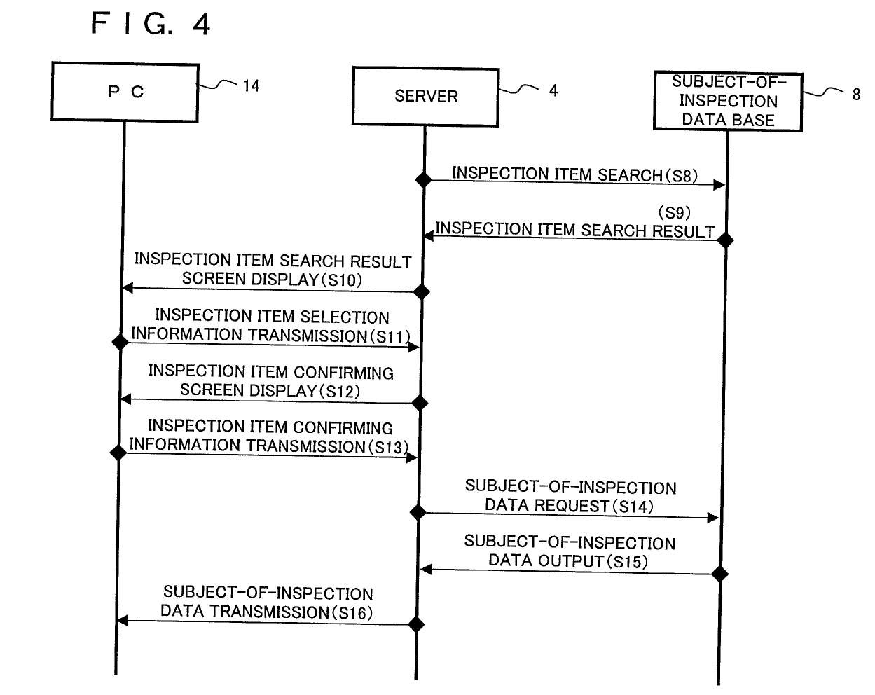

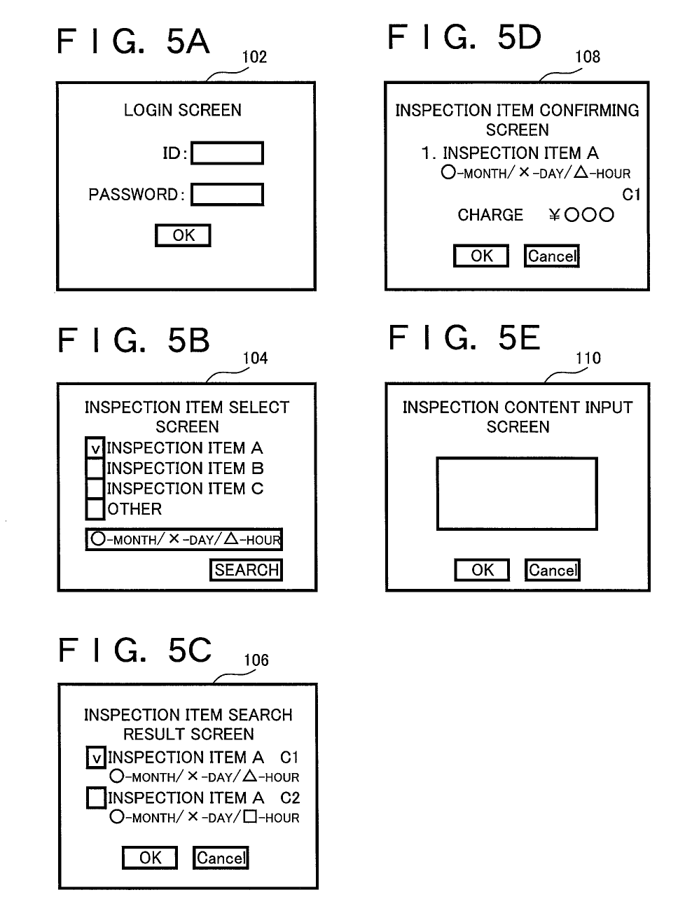

Next, explanation is made on a factory inspecting method according to the present embodiment, using FIG. 3 to FIG. 5E. FIG. 3 and FIG. 4 show a flow of data between the PC 14 of client section 12, the server 4 of server section 2 and the subject-of-inspection database 8. Meanwhile, FIGS. 5A to 5E show examples of displaying on a browser screen of the PC 14.

The explanation on the factory inspecting method of the embodiment is premised on that the client has previously acquired from the server section 2 an ID and password for requesting a factory inspection. The ID and password may be acquired through the communication network 1 or by way of a proceeding using a document. The client who acquired an ID and password (hereinafter, referred to as “member”) inputs a predetermined URL (Uniform Resource Locator) on a browser screen of the PC 14, thereby accessing the server 4 through the communication network (step S1 of FIG. 3). The server 4 reads, from a not-shown storage device, the data for displaying an inspection-requesting login screen 102 as shown in FIG. 5A and transmits the same data to the PC 14 (step S2). The member inputs an ID and password in an input form on a login screen 102 and then presses an button “OK”. This transmits the ID and password from the PC 14 to the server 4 (step S3).

The server 4, received the ID and password, searches for the ID and password through the subject-of-inspection database 8 (step S4). In the case that the ID and password is registered in the subject-of-inspection database 8, the server 4 reads, from the subject-of-inspection database 8, the data for displaying an inspection-item select screen 104 as shown in FIG. 5B on the browser screen (step S5) and transmits the same data to the PC 14 (step S6). In the case that the ID and password is not registered in the subject-of-inspection database 8, the server 4 again transmits to the PC 14 the data for displaying a login screen 102 on the browser screen.

The inspection-item select screen 104 is arranged to display, for example, only the inspection items related to the member, allowing selection from a plurality of inspection items (three of A to C,in the figure). Meanwhile, the inspection-item select screen 104 is further allowed for narrowing search by designating, with keywords, a product kind, lot, date/hour, process, camera-apparatus 10 position, etc. When the member selects a desired inspection item (e.g. “inspection item A”) and inputs a keyword (e.g. “O-MONTH/×-DAY/Δ-HOUR”) to press the button “SEARCH”, an inspection-item selection result and narrowing-search information is transmitted from the PC 14 to the server 4 (step S7).

The server 4, received the inspection item search information, searches for subject-of-inspection data relevant to the inspection-item search information throughout the subject-of-inspection database 8 (step S8 in FIG. 4) and reads out an inspection-item search result (step S9).

Herein, when “OTHER” is selected on the inspection-item select screen 104, the process does not proceed to step S8 and the subsequent, i.e. the server 4 reads from the subject-of-inspection database 8 the data for displaying on the browser screen an inspection-content input screen 110 as shown in FIG. 5E, and transmits the same data to the PC 14. The member inputs a concrete inspection content to the input format on the inspection-content input screen 110 and then presses the button “OK”. Due to this, the PC 14 transmits an inspection content to the server 4. The supplier examines the inspection content received by the server 4 and prepares a response concerning charge, etc. The response is transmitted later day by electronic mail or the like to the member.

Next, the server 4, read out an inspection item search result in step S9, transmits to the PC 14 the data for displaying on the browser screen an inspection-item search result screen 106 as shown in FIG. 5C (step S10). On the inspection item search result screen 106 are displayed two of subject-of-inspection data selected on the basis of the inspection item. The subject-of-inspection data represents, at the upper line, the image data generated by the first camera apparatus 10 (C1) and, at the lower line, the image data generated by the second camera apparatus 10. Each of subject-of-inspection data, although to be selected by a check box, maybe configured for further narrowing search. When the member selects a desired one of subject-of-inspection data (e.g. INSPECTION ITEM A O-MONTH/×-DAY/Δ-HOUR C1”) from those on the inspection-item search result screen 106 and then presses the button “OK”, inspection-item selection information is transmitted from the PC 14 to the server 4 (step S11).

The server 4 calculates a charge on the basis of received inspection-item selection information, and reads from the storage device the data for displaying on the browser screen an inspection-item confirming screen 108 as shown in FIG. 5D to transmit the same data to the PC 14 (step S12). Displayed on the inspection-item confirming screen 108 are one or a plurality of defined inspection items and the charge for the subject-of-inspection data relevant to that inspection item. When the member confirms the inspection item and consents to the charge to press the button “OK”, an inspection contract is established. Inspection-item confirming information is transmitted from the PC 14 to the server 4 (step S13). At this time, if the member is discontented with the charge displayed on the inspection-item confirming screen 108, the inspection request can be canceled by pressing a button “CANCEL”.

The server 4, received the inspection-item confirming information, requests the subject-of-inspection data relevant to the inspection-item confirming information to the subject-of -inspection database 8 (step S14) and reads the subject-of-inspection data from the subject-of-inspection database 8 (step S15). Subsequently, the subject-of-inspection data read out of the subject-of-inspection database 8 is transmitted to the PC 14 (step S16). The member carries out an inspection on the basis of the subject-of-inspection data received by the PC 14.

The above explanation is on the case using the subject-of-inspection data previously written in the subject-of-inspection database 8. For example, where real-time image data is selected as an inspection item by a member, the server 4 is adapted to read out the image data having a stamp of a date/hour and position generated real-time by the camera apparatus 10 and transmit it to the PC 14.

Incidentally, the inspection-item confirming screen 108 may display together such cost of traffic expenses, hotel expenses and reception expenses, required time and available period as required in an inspection by the conventional factory inspecting method. This makes it possible to appeal on speedy response and high economical efficiency in the factory inspection method of this embodiment. Meanwhile, in the case the client is of a small business, e.g. an individual, charge may be settled through the communication network 1 by inputting a credit card number to a not-shown input form.

Although the charge increases with increase of the number of inspection items, charge is displayed on an inspection-item confirming screen 108 finally defining an inspection item. Accordingly, the number of inspection items can be reduced to adjust charge before acquiring subject-of-inspection data.

In the present embodiment, the image data as subjects of factory inspection previously made in a definite form is stored in the subject-of-inspection database 8 so that search can be made for the image data under a condition (product kind, lot, date/hour, process, camera apparatus position, etc.) suited for the requirement by a client. Consequently, by a client's inspection at a desired date/hour on the basis of the image data immediately received through the communication network 1 by the foregoing procedure, it is possible for both the client and the supplier to greatly reduce the number of processes in manpower and time required for factory inspection. Thus, inspection can be properly carried out easily and rapidly. Meanwhile, according to this embodiment, the supplier is allowed to change the passive stance a factory inspection is to be made after receiving a request from a client to an active stance to implement a factory inspection of a content at a date/hour desired by a client. Consequently, the client can acquire inspection data required in an early stage. Furthermore, according to this embodiment, the expenditure such as traffic expenses, hotel expenses and reception expenses can be greatly reduced as compared to the case the client actually visits a factory for inspection.

Meanwhile, by charging the conventional passive-formed factory inspection conducted free of charge at the supplier side with using the method and system for factory inspection of this embodiment, motivation is given for active business with quality control in the manufacture process. Furthermore, because of easy request proceeding for a factory inspection, even a new client can readily request a proper inspection to the supplier. Accordingly, the supplier is easy to develop new clients, thus having broadened chances in acquiring the total business without limitation to factory inspection.

Meanwhile, by calculating a charge of subject-of-inspection data by the server 4, the supplier can reduce the number of processes in manpower and time. Furthermore, because the client is allowed for inspection after confirming and consenting to a charge on the browser screen, the trouble with a client on charge is avoided while the client can readily request for an inspection. Consequently, the supplier can deepen the relationship of reliability with the client without spending the process of manpower. Meanwhile, the subject-of-inspection data supplied includes a stamp certifying a time and position the relevant data has been generated, the subject-of-inspection data for the client is improved in reliability.

The present invention is not limited to the foregoing embodiment but can be modified in various ways.

For example, although the embodiment is exemplified on factory inspection, the invention is not limited to that but can be broadly applied for monitor systems, security systems and so on.

As in the foregoing, the present invention can carry out a proper inspection easily and rapidly.

What is claimed is:

1. A method for factory inspection comprising the steps of:
transmitting a desired inspection item through a communication network when conducting a factory inspection; and
receiving subject-of-inspection data selected on the basis of the inspection item through the communication network.

2. A method for factory inspection according to claim 1, wherein the subject-of-inspection data is image data taken a picture of a subject of inspection.

3. A method for factory inspection according to claim 2, wherein the image data is animation.

4. A method for factory inspection according to claim 1, wherein the subject-of -inspection data contains data of a date/hour that the subject-of-inspection data has been generated.

5. A method for factory inspection according to claim 4, wherein the generated date/hour data is obtained on the basis of a standard time signal received from an artificial satellite.

6. A method for factory inspection according to claim 4, wherein the generated date/hour data is obtained on the basis of a standard time signal received from a standard radio-wave transmitting station.

7. A method for factory inspection according to claim 4, wherein the generated date/hour data is obtained on the basis of a time signal received through a public telephone line.

8. A method for factory inspection according to claim 4, wherein the generated date/hour data is encrypted.

9. A method for factory inspection according to claim 1, wherein the subject-of-inspection data contains data of a position that the subject-of-inspection data has been generated.

10. A method for factory inspection according to claim 9, wherein the position data is obtained on the basis of a radio wave received from an artificial satellite.

11. A method for factory inspection according to claim 9, wherein the position data is encrypted.

12. A system for factory inspection comprising:
a server section for monitoring a subject of inspection to generate subject-of-inspection data and transmitting the subject-of-inspection data; and
a client section for receiving the subject-of-inspection data through a communication network and carrying out an inspection on the basis of the subject-of-inspection data.
